(19) United States
(12) Patent Application Publication
(10) Pub. No.: US 2009/0096772 A1
(43) Pub. Date: Apr. 16, 2009

(54) IMAGE DISPLAY APPARATUS AND ITS DISPLAY METHOD

(75) Inventor: Kenta Kinoshita, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 12/280,971

(22) PCT Filed: Feb. 26, 2007
(86) PCT No.: PCT/JP2007/053536

§ 371 Date: Dec. 2, 2008

(30) Foreign Application Priority Data
Feb. 7, 2006 (JP) 2006-50545

(51) Int. Cl. G09G 5/00; G09G 3/34

(52) U.S. Cl. 345/204; 345/84

(57) ABSTRACT

An image display apparatus (100) comprises a calculation unit 164A) for calculating respective luminance value of pixels of an image data and a total luminance value which is a sum of luminance values of the pixels; a conversion unit (164B) for converting a pixel having the second lowest luminance value excluding a pixel having the lowest luminance value among pixels composing the image data into a pixel having the lowest luminance value, until the total luminance value calculated by the calculation unit becomes a predetermined luminance value; and a display unit (140) which displays image data including a pixel converted by the conversion unit and has a plurality of arranged pixels composed of self-emitting devices.

### TECHNICAL FIELD

The present invention relates to an image display apparatus and a display method thereof.

### RELATED ART

As self-emitting devices have a characteristic that power consumption is changed according to colors they display, it has been attempted to proactively use colors with low power consumption (black, green) for a standby screen and the like of a mobile phone. Moreover, self-emitting devices generally consume more power than a liquid crystal device. Therefore, in apparatus using a battery with small power such as a mobile terminal, a method for saving power such as controlling a display region having a small change to be unlighted has been employed. As measures to save power of the self-emitting device, techniques that change colors of pixels to colors with low power consumption have been mainly used. As such techniques, there are a method that controls the brightness of an image display region according to residual quantity of a battery (see Patent Document 1), a method that thins out pixels of RGB colors according to residual quantity of a battery (see Patent Document 2), and a method that thins out background colors in a line shape or checkered pattern (see Patent Document 3).

### Patent Document 1: Japanese Patent Application Laid-open No. 2004-12600

### Patent Document 2: Japanese Patent Application Laid-open No. 2004-198809

### Patent Document 3: Japanese Patent Application Laid-open No. 2004-12655

### DISCLOSURE OF THE INVENTION

### Problems to be Solved by the Invention

However, the measures for saving power according to conventional methods have problems that display colors of an original image are changed to different colors when the power saving control is executed, and that a screen gets dark when remaining battery level becomes low. Therefore, user's visibility cannot be satisfied. Moreover, while a user continuously watches the screen playing such as a moving picture, the image is suddenly changed, so that the user feels incongruous strongly.

### SUMMARY OF THE INVENTION

To solve the above problems, an image display apparatus according to the present invention comprises:

(a storage unit for storing image data composed of pixels each having luminance values);
a calculation unit for calculating respective luminance values of the pixels of an image data (read out from the storage unit) and a total luminance value which is a sum of luminance values of the pixels;
a conversion unit for converting a pixel having the second lowest luminance value next to a pixel having the lowest luminance value among pixels composing the image data, into a pixel having the lowest luminance value (typically, it is a black point, i.e., light non-emitting pixel/non-lighting pixel), until the total luminance value calculated by the calculation unit becomes a predetermined luminance value (which is in the range where user's visibility is not deteriorated, in other words, there is no influence on reproduction of an original image, and which is enough to achieve power saving, for example, below 80%); and
a display unit which displays image data including a pixel converted by the conversion unit and has a plurality of arranged pixels composed of self-emitting devices.

An image display apparatus according to one embodiment of the present invention comprise:

(a storage unit for storing image data composed of pixels each having luminance values;)
a calculation unit for calculating respective luminance values of the pixels of an image data (read out from the storage unit) and a total luminance value which is a sum of luminance values of the pixels;
a conversion unit for converting a pixel excluding a pixel having the lowest luminance value among pixels composing the image data, into a pixel having the lowest luminance value (typically, it is a black point, i.e., light non-emitting pixel/non-lighting pixel) with higher frequency as the luminance value of a pixel is lower, until the total luminance value calculated by the calculation unit becomes a predetermined luminance value (which is in the range where user's visibility is not deteriorated, and which is enough to achieve power saving, for example, below 80%); and
a display unit which displays image data including a pixel converted by the conversion unit and has a plurality of arranged pixels composed of self-emitting devices.

In an image display apparatus according to another embodiment of the present invention,

image data of which luminance value is calculated by the calculation unit is a reference frame (for example, I-frame in MPEG) in frames constructing a moving picture.

In an image display apparatus according to still another embodiment of the present invention,

the conversion unit keeps each pixel converted to have the lowest luminance value of the reference frame in the lowest luminance value until it reaches to a next reference frame (in other words, converts corresponding pixels of each frame between reference frames (B, P frames between reference I-frames in case of MPEG) into pixels having the lowest luminance value).

In an image display apparatus according to still further another embodiment of the present invention,

the pixel having the lowest luminance value is a pixel that is not lighted (does not emit light).

While the present invention is achieved by devices in above description, the present invention can be realized as a method, program or a recording medium recording a program substantially corresponding to them, and it is to be understood that these are included within the scope of the present invention. For example, a display method of an image display apparatus according to another aspect in which the present invention is realized as a method, is a display method of an image display apparatus with a display unit which has a plurality of arranged pixels composed of self-emitting devices, and comprises steps of:

(storing image data composed of pixels each having luminance values into a storage unit;)
(calculating respective luminance values of the pixels of an image data read out from the storage unit and a total luminance value which is a sum of luminance values of the pixels by using a calculation unit;)
converting a pixel having the second lowest luminance value next to a pixel having the lowest luminance value among pixels composing the image data, into a pixel having the lowest luminance value, until a total luminance value which is calculated above and which is a sum of luminance values of pixels of image data to be displayed on the display unit becomes a predetermined luminance value; and displaying image data including the converted pixel on the display unit.

A display method of an image display apparatus according to an embodiment of the present invention in which the image display apparatus comprises a display unit having a plurality of arranged pixels composed of self-emitting devices comprises steps of:

converting a pixel excluding a pixel having the lowest luminance value among pixels composing the image data, into a pixel having the lowest luminance value with higher frequency as the luminance value of a pixel is lower, until a total luminance value which is a sum of luminance values of pixels of image data to be displayed on the display unit becomes a predetermined luminance value; and displaying image data including the converted pixel on the display unit.

### EFFECT OF THE INVENTION

According to the present invention, it is possible to achieve power saving with satisfying user's visibility by inserting black colors whose power consumptions are the least into a frame on a pixel basis. In other words, the present invention can satisfy user's visibility with keeping up the original image display in case a moving picture is played by a mobile terminal with a self-emitting device such as OLED.

### BRIEF DESCRIPTION OF THE DRAWINGS

FIG. 1 is a block diagram showing image display function blocks of a mobile terminal according to the present invention;

FIG. 2 shows correlation graphs between colors and power consumption for organic light-emitting diodes (OLED));

FIG. 3 is a schematic diagram showing a case that a white image is converted to an image of 80% power consumption by the image conversion algorithm according to the present invention;

FIG. 4 shows an example of calculating energy consumption of a natural image and inserting black points to the image;

FIG. 5 is a flowchart showing a process flow of an image conversion algorithm of a mobile terminal according to the present invention;

FIG. 6 is a flowchart of a sub-routine for frame energy consumption calculating process only carried out for I-frame;

FIG. 7 is a flowchart of a sub-routine for black point insertion position determining process;

FIG. 8 shows an energy value information table;

FIG. 9 is a schematic diagram showing that a moving picture is played by a terminal when a user sets 90% power saving;

FIG. 10 shows an example of calculations when black points are inserted after the color of entire image is converted to the color with 90% power consumption using the correlation graph;

FIG. 11 is a flowchart when all pixels are converted to pixels of L % power saving by the correlation color conversion;

FIG. 12 shows an image on which an image conversion has been performed; FIG. 12(a) shows an original image; and

FIG. 13 is a block diagram of a mobile terminal having a conventional self-emitting display unit.

### BEST MODE FOR CARRYING OUT TE INVENTION

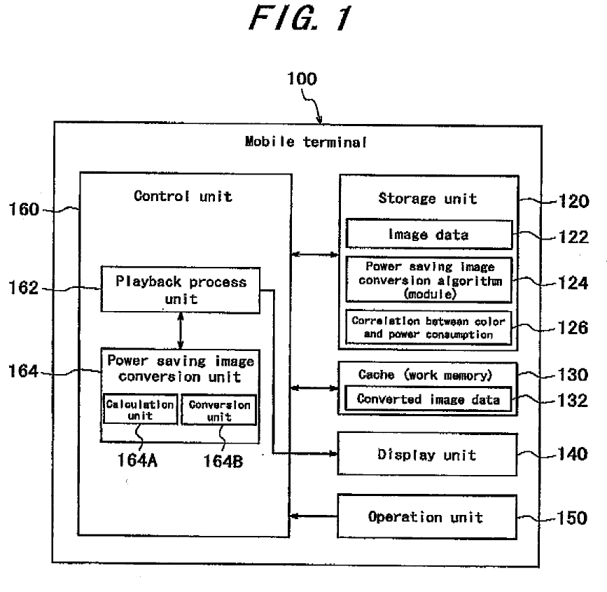

Preferred embodiments of the present invention will now be described with reference to the accompanying drawings. It will be described that the present invention is applied to a mobile terminal (portable terminal apparatus), as a typical example of an image display apparatus with a self-emitting device. FIG. 1 is a block diagram showing image display function blocks of a mobile terminal according to the present invention. As shown in FIG. 1, the mobile terminal 100 according to the present invention has a storage unit 120, a cache (work memory) 130, a display unit 140, an operation unit 150 and a control unit 160. The storage unit 120 stores image data 122 before power saving conversion, a power saving image conversion algorithm (program module) 124 and correlation information 126 between color and power consumption. The cache 130 temporarily stores image data read out from the storage unit and various data in process, especially, converted image data 132 including pixels after conversion. The display unit 140 is composed of self-emitting devices, and displays an image controlled by the control unit 160. The operation unit 150 is a block for receiving an input from a user. The control unit 160 processes data according to settings stored in the storage unit 120, and controls each unit. The control unit 160 includes a playback process unit 162 and a power saving image conversion unit 164. The playback process unit 162 performs processes for decoding and playing image data stored in the storage unit 120. The power saving image conversion unit 164 performs a conversion process of image data decoded by the playback process unit 162 with a power saving image conversion algorithm 124. The power saving image conversion unit 164 has a calculation unit 164A for calculating a luminance value of each pixel of image data and a total luminance value that is a sum of luminance values of the pixels, and for performing other related calculations; and a conversion unit 164B for converting a pixels having the second lowest luminance value excluding a pixel having the lowest luminance value among pixels composing the image data, into a pixel having the lowest luminance value or into a pixel having a correlated color, until the total luminance value calculated in the calculation unit becomes a predetermined luminance value. With the above construction, it is possible to save power of a mobile terminal without making a user recognize the change of image quality, so that continuous operation time is increased.

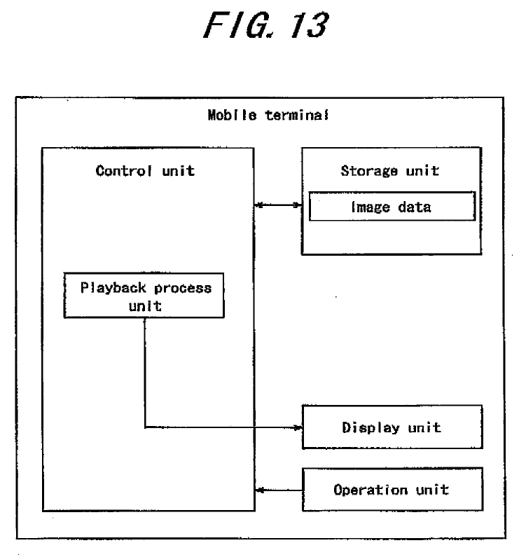

FIG. 13 is a block diagram of a mobile terminal having a conventional self-emitting display unit. When comparing the construction of FIG. 1 with the conventional construction of FIG. 13, the power saving image conversion algorithm 124 and the correlation information between color and power consumption 126 are added to the storage unit 120 of FIG. 1; and the power saving image conversion unit 164 is added to the control unit 160. These are main parts of the present invention.

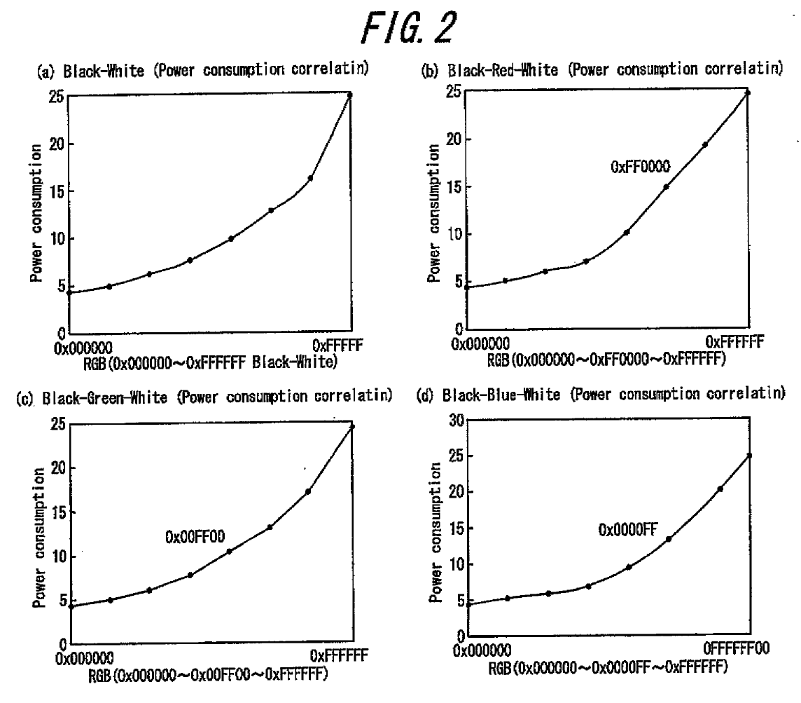

The power consumption of the present invention may be referred to as energy consumption or energy. FIG. 2 shows correlation graphs between colors and power consumption for organic light-emitting diodes (OLED). The horizontal axis indicates RGB codes, and the vertical axis indicates power consumption. The correlation graphs between colors and power consumption are acquired by corresponding power consumption of colors, respectively. The correlation graphs between colors and power consumption (so-called RGB888 type which indicates each color of RGB with 8 bits: 256 colors) are divided into four types as follows:

1) Relation of power consumption in a monochrome of black and white (0×000000˜0×******˜0×ffffff);
2) Relation of power consumption to gradation of red (RGB: 0*000000˜0×00**00˜0×00ff00˜0×ff****˜0×ffffff);
3) Relation of power consumption to gradation of green (RGB: 0*000000˜0×00**00˜0×00ff00˜0×**ff**˜0×ffffff); and
4) Relation of power consumption to gradation of blue (0×000000˜0×0000**˜0×0000ff˜0×****ff˜0×ffffff).
It is possible to indicate correlations between every colors and power consumption by the above-mentioned four types. There are nonlinear relations in which power consumption is as high as white (0×ffffff), and power consumption is as low as black (0×000000). By storing these relations in the storage unit it is possible to calculate power consumption for one pixel. When energy consumption for white is assumed to 100, power consumption for black is about 17. This does not mean that a black pixel actually consumes the electric power for emission, but means that standby power and the like is consumed to drive pixels. In here, the energy consumption for black is defined as 0 for convenience, as it also means that the pixel is not lighted. Actually, a rate of each color in case that white is 100 and black is 0 is stored in the storage unit as a value.

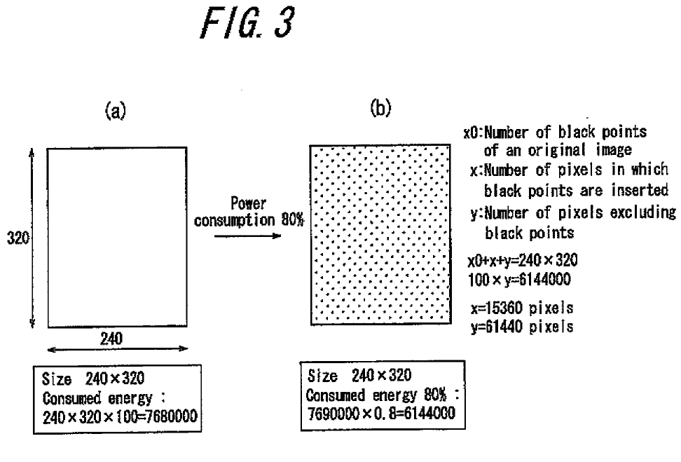

FIG. 3 is a schematic diagram showing a case that a white image is converted to an image of 80% power consumption by the image conversion algorithm according to the present invention. It shows a calculation example, on the right side, about how many black points are appropriate to be inserted for conversion to the image of FIG. 3(b) with power consumption reduced to 80% by calculating energy consumption from a white (0×ffffff) frame composed of 320×240 pixels shown in FIG. 3(a). In here, the black point is a pixel having the lowest luminance. However, the insertion number of black points can be determined by calculating energy consumption of a frame based on correlation graph between color and power consumption.

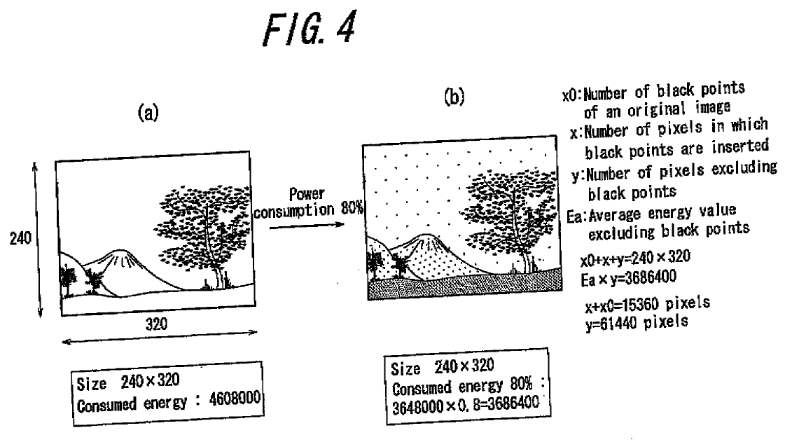

FIG. 4 shows an example of calculating energy consumption and inserting black points when a natural image is displayed. In here, it is assumed that image packets having MPEG format are transmitted. Average energy consumption Ea excluding black points is calculated by scanning the frame, and the insertion number of black points x is calculated. When seeing the image (power saving condition) after power consumption is converted from 100% (normal condition) to 80%, it may be figured out that there are characteristics in the method of inserting black points. When black points are inserted, pixels are replaced according to following rules:

i) Raising the frequency, as the color of a pixel is closer to black; and lowering the frequency, as the color of a pixel is closer to white;
ii) Not replacing original black pixels; and
iii) In the case of MPEG frames, changing insertion positions of black points only for I-frame. For other frames (P, B), the black points are inserted on the same positions with I-frame. In other words, insertion positions of black points are changed by analyzing a frame every 15 frames.
According to the rule i), the probability of being converted to a black point becomes higher, as the color of a pixel is closer to black; and the probability of being converted to a black point becomes lower, as the color of a pixel is closer to white. Therefore, there is an advantage that a user can hardly recognize the change of image quality. In FIG. 4(b), since the sky located on the upper left side of the figure is bright and is far from black, the insertion number of black points is small. In addition, since the mountain located on the lower left side of the figure is close to black, the insertion number of black points is large. The ground portion on the lowest side is gray that is the closest to the black, so that the insertion number of black points is the largest in the figure. Moreover, as the insertion positions of black points are changed at a predetermined interval according to the rule iii), a user can view a moving picture without recognizing that black points are being inserted.

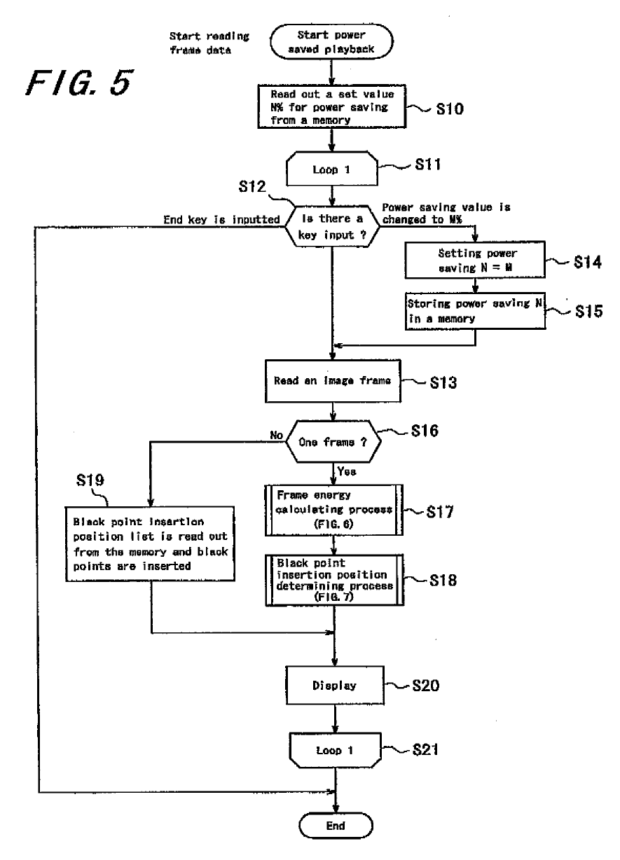

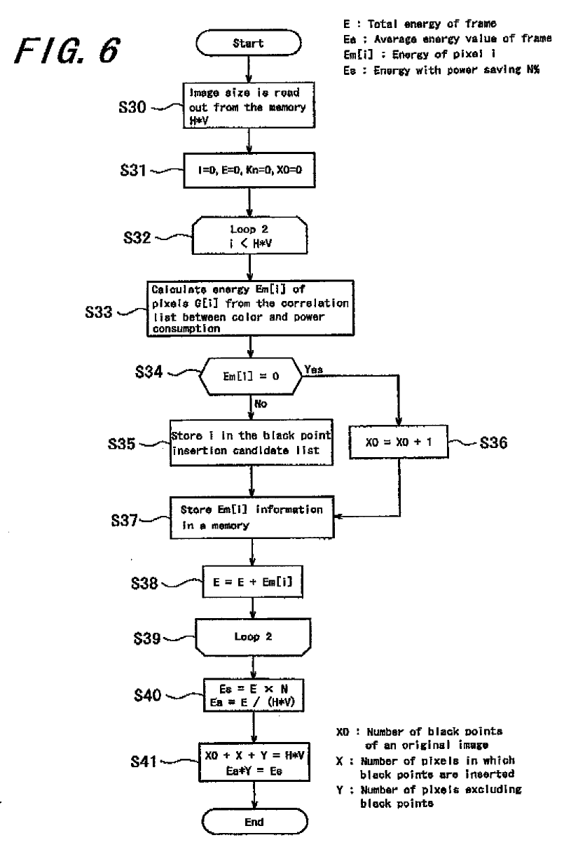

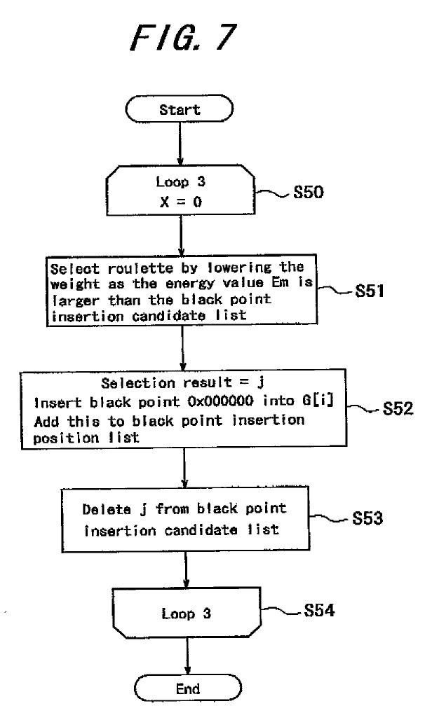

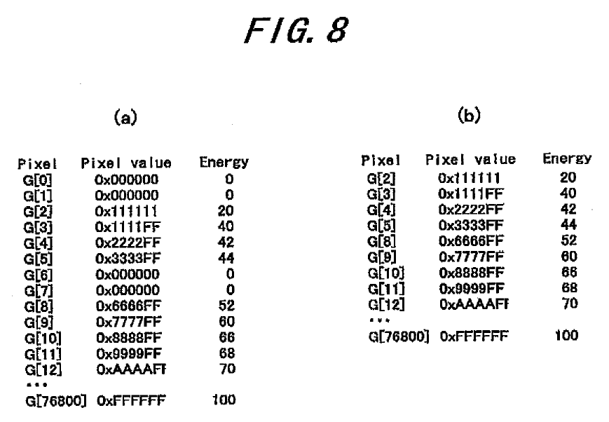

FIG. 5 is a flowchart showing a process flow of the image conversion algorithm of a mobile terminal according to the present invention. In the flowchart of FIG. 5, a sub-routine for frame energy consumption calculating process (FIG. 6) and a sub-routine for black point insertion position determining process (FIG. 7) are carried out for only I-frames. When the frame energy consumption calculating process is performed, an energy value information table is stored in the storage unit as shown in FIG. 8, and pixels excluding the black pixels are stored in the storage unit like the table and a black point insertion candidate list. In the black point insertion position determining process, pixels to be converted to black points are selected from the black point insertion candidate list. As a selection method of black point insertion positions, for example, a weighting method is employed to raise probability for selecting a pixel with low power consumption, and to lower probability for selecting a pixel with high power consumption. The black point insertion position list is stored in the storage unit, and black points are inserted according to the same black point insertion position list for the other frames (B, P frames) excluding I-frames. Below, it will be described about each flowchart in detail.

As shown in FIG. 5, after frame data are read, the power saved playback using the image conversion algorithm according to the present invention is started. In step S10, a set value N % for power saving is read out from a memory. Steps S11˜S21 are repeated as a loop 1 until a predetermined condition is met. In step S12 included in the loop 1, it is determined whether there is a key input. If an end key is inputted, loop l is ended. If there is no key input, the process flow proceeds to step S13 where a target image frame for image conversion is read. Next, it is determined whether or not the image is an I-frame (S16). If it is not an I-frame, the black point insertion position list made in the process of prior I-frame is read out from the memory, and black points are inserted into the frame using the list (S19). If it is an I-frame, the process flow proceeds to steps 17 and 18 to execute the sub-routine for frame energy consumption calculating process (FIG. 6) and the sub-routine for black point insertion position determining process (FIG. 7) (these sub-routine processes will be described later in detail). After the sub-routine processes are complete, the process flow proceeds to step S20 to perform display. The process of loop 1 is repeated until an end condition is met (S21).

FIG. 6 is a flowchart of the sub-routine for frame energy consumption calculating process only carried out for I-frame. As shown in FIG. 6, in step S30, an image size (the number of pixels) is read out from the memory, and variables are reset (S31). Steps S32˜S39 are repeated as a process of loop2, and the process is repeated until an end condition is met. In here, the end condition is that the variable i becomes the image size. In a process step S33 included in the loop 2, energy Em[i] of a pixel G[i] is calculated from the correlation list between color and power consumption. Next, it is determined whether a target pixel is a black point or not using a determination result about whether the calculated Em[i] is equal to zero or not (S34). If the Em[i] is equal to zero (the target pixel is a black point), the process flow proceeds to step 36 where it is counted as the number of black points of the original image. If it is not a black point, the number i of the target pixel is stored in the black point insertion candidate list (S35), and its energy value is also stored in the memory (S37). Lastly, the energy value is summed as a total energy value (S38), and the process of the loop 2 is repeated until an end condition is met (S39, see FIG. 8(a)).

After the process of the loop 2 is complete, it proceeds to step S40 where an energy value Es of N % power saving and an average energy value Ea of a frame are calculated. In step S41, following calculations are performed and the process is finished.

The number of black points of an original image X0+the number of pixels in which black points are inserted X+the number of pixels excluding black points Y=total number of pixels (H×V)

Ea×Y=Es

FIG. 7 is a flowchart of the sub-routine for black point insertion position S determining process. As shown in FIG. 7, in step S50, the insertion number of black points X is reset to zero. Steps S50˜S54 are repeated as a process of loop 3, and the process is repeated until an end condition is met. In step S51 included in the loop 3, roulette selection is performed by lowering the weight (selection frequency), as the energy value Em is larger, by using the black point insertion candidate list (see FIG. 8(b)). When the selection result is j, a black point is inserted into G[j], and this is added to the black point insertion position list (S52). The pixel number j that has been processed is deleted from the black point insertion candidate list, and a needed post-process of variables (decrement) is performed (S53). In addition, the process of the loop 3 is repeated until an end condition is met (S54).

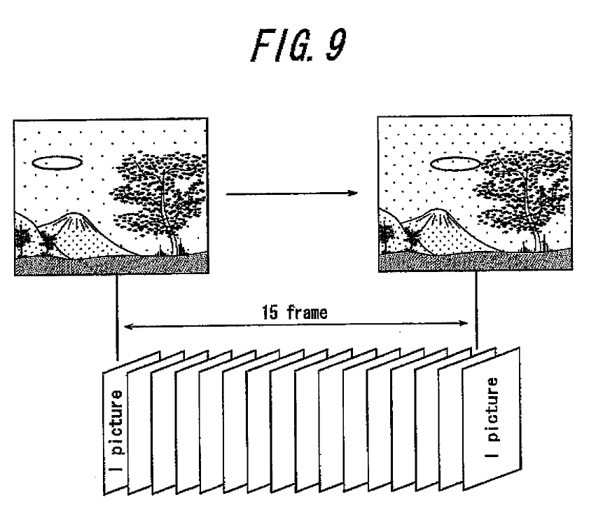

FIG. 9 is a schematic diagram showing that a moving picture is played by a terminal when a user sets 90% power saving. Black points in the figure indicate inserted black points. However, this is a schematic diagram, so that the size of a black point, insertion position, insertion number and the like are different from actual things. Although it depends on the set value for power saving, a user can hardly recognize that black points are being inserted while a moving picture is played. The moving picture is played with changing insertion positions of black points at every I-frame according to the image conversion algorithm of the present invention. The ellipse in the figure schematically shows that insertion positions of black points are changed on an I-frame basis. While a moving picture is played, it is possible to achieve 90% power saving without making a user recognize the change of image quality although the image quality is changed, in the strict sense, due to insertion of black points.

As described above, it is possible to achieve the power saving by inserting black points as pixels having the lowest luminance. However, when the degree of power saving is too high, the insertion number of black points is increased. In this case, a picture may be difficult to see. Accordingly, in the present invention, it is possible to reduce the insertion number of black points by performing conversion to colors that are in same series and have low power consumption using the correlation graphs between colors and power consumption. Hereinafter, conversion to color with low power consumption is referred to as a correlation color conversion.

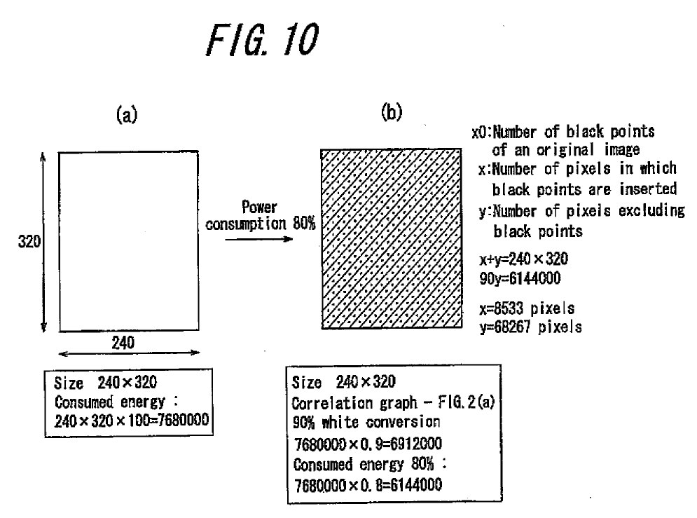

FIG. 10 shows an example of calculations for converting a white (0×ffffff) image composed of 320×240 pixels into an image of 80% power saving. In the FIG. 10, the color of entire image is converted into the color with 90% power consumption using the correlation graph of FIG. 2, and then black points are inserted. The color of image is converted into the color with 90% power consumption by employing the correlation graph for white (0×ffffff) of FIG. 2(a) (it has the same meaning with lowering luminance). FIG. 10(b) shows an image after conversion, and hatching shows the conversion to correlation color with 90% power consumption, schematically (this is also applied to other figures). Comparing FIG. 4 with FIG. 10, it is possible to reduce the insertion number of black points from 15,360 pixels to 8,533 pixels by converting whole pixels to pixels with 90% power consumption. Moreover, because a pixel is not converted to be completely different color by the conversion with the correlation graph, a user can view an image close to a natural image. The hatching of correlation color conversion of FIG. 10(b) is inserted for convenience for drawing figures and explanation. Although it depends on the power saving set value, a user can hardly recognize the conversion while a moving picture is played.

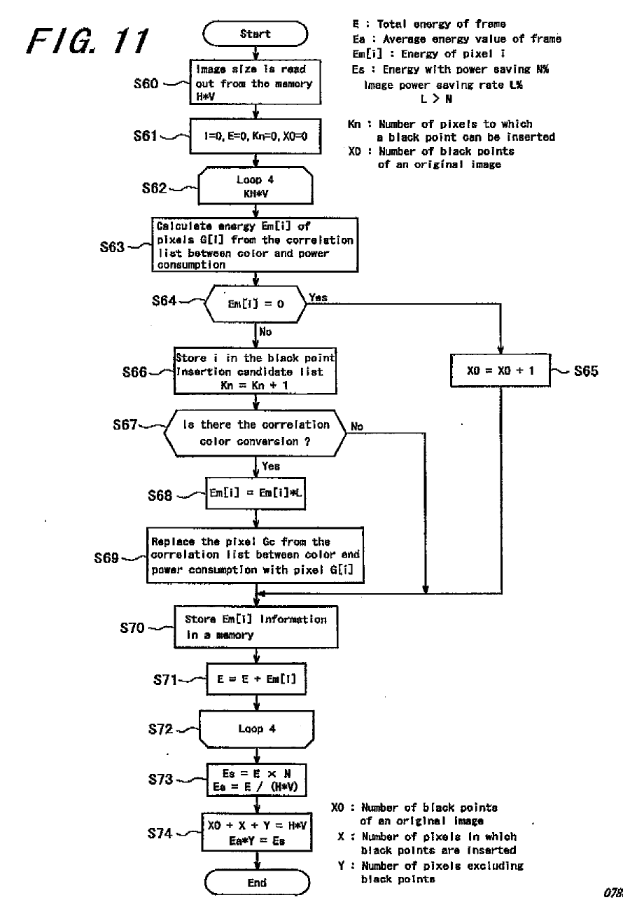

FIG. 11 is a flowchart when all pixels are converted to pixels of L % power saving by the correlation color conversion. When comparing the process of FIG. 11 with that of FIG. 5, there are changes in the frame energy consumption calculating flow. Other steps S60-66, S70-74 are same with corresponding steps in FIG. 5. After storing a target pixel number i into the black point insertion candidate list (S66), in step S67, it is determined whether there is the correlation color conversion. If the condition is satisfied, an energy value is calculated with an aimed image power saving rate L, and set as an energy value (S68). A target pixel is converted to a color having correlation and not making a sense of incongruity from the correlation color list (S69). By these processes, it is possible to reduce the insertion number of black points.

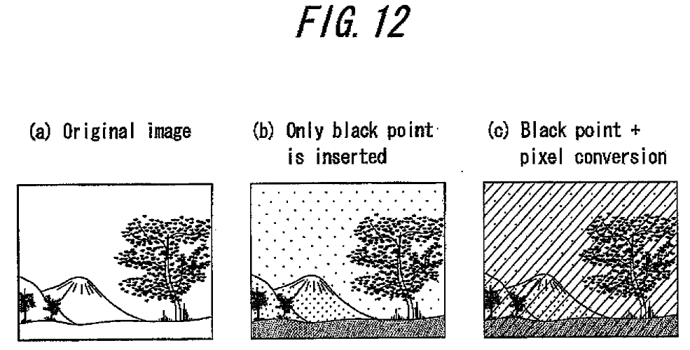

FIG. 12 shows an image on which an image conversion is performed. FIG. 12(a) shows an original image; FIG. 12(b) shows an image after only black point inserting conversion is performed; and FIG. 12(c) shows an image after the correlation color conversion is performed and then black points are inserted (the insertion number of black points is lower than that of FIG. 12(b) due to the color conversion). It depends on the user's policy whether a process for decreasing the insertion number of black points with lowering luminance (perform the correlation color conversion) or a process for inserting black points without lowering luminance is performed.

The present invention employs the power saved image conversion algorithm that can satisfy user's visibility with keeping up original image display, when a moving picture is played by a mobile terminal with a self-emitting device such as OLED. By this, the following advantages are obtained. In the power saving image conversion, it is possible to save power by inserting black color whose power consumption is very small into a frame on a pixel basis. When a user views a moving picture, the conversion is performed with predetermined frame interval so as to satisfy user's visibility. For example, as describe above, black point insertion positions may be changed at every I-frame in case of the MPEG format. As the result a user is difficult to recognize that there are black points, so that it is possible to achieve power saving with keeping image information. In the power saving image conversion algorithm, correlation data between color and electric power are stored in a memory unit, and electric energy consumption, in case one frame is played, is calculated. There are four correlation data of monochrome, R, G, B in the correlation data between colors and electric power. In order to decrease the insertion number of black points, it is possible to convert a color with large power consumption into a color with small power consumption based on the correlation data. In this case, it is possible to achieve power saving in the form of being close to the original color without changing the original color to completely different color. The present invention can achieve power saving without making a user recognized because it does not change a pixel suddenly according to the residual quantity of a battery like the conventional method. Therefore, the present invention is effective especially when there is consecutive playback such as moving picture.

The present invention has been described based on the drawings and embodiments, but it should be noted that a person skilled in the art could verify or modify this invention easily based on the description. Therefore it is to be understood that variations and modifications is included within the scope of the invention. For example, functions included in each member, means, step and the like can be rearranged with avoiding logical contradiction. Moreover, a plurality of means and steps can be combined or divided.

### CROSS REFERENCE TO RELATED APPLICATION

This application claims priority to and the benefit of Japan Patent Application No. 2006-50545 filed on Feb. 27, 2007, the entire content of which is incorporated herein by reference.

1. An image display apparatus comprising:
a calculation unit for calculating respective luminance values of pixels of an image data and a total luminance value which is a sum of luminance values of the pixels;
a conversion unit for converting a pixel having a second lowest luminance value next to a pixel having a lowest luminance value among pixels composing the image data, into a pixel having a lowest luminance value, until the total luminance value calculated by the calculation unit becomes a predetermined luminance value; and
a display unit which displays image data including a pixel converted by the conversion unit and has a plurality of arranged pixels composed of self-emitting devices.

2. The image display apparatus of claim 1, wherein image data of which luminance value is calculated by the calculation unit is a reference frame in frames constructing a moving picture.

3. The image display apparatus of claim 2, wherein the conversion unit keeps each pixel converted to have a lowest luminance value of the reference frame in the lowest luminance value until it reaches to a next reference frame.

4. The image display apparatus of claim 1, wherein the pixel having the lowest luminance value is a pixel that is not lighted.

5. An image display apparatus comprising.
a calculation unit for calculating respective luminance value of pixels of an image data and a total luminance value which is a sum of luminance values of the pixels;
a conversion unit for converting a pixel excluding a pixel having a lowest luminance value among pixels composing the image data, into a pixel having a lowest luminance value with higher frequency as a luminance value of a pixel is lower, until the total luminance value calculated by the calculation unit becomes a predetermined luminance value; and
a display unit which displays image data including a pixel converted by the conversion unit and has a plurality of arranged pixels composed of self-emitting devices.

6. The image display apparatus of claim 5, wherein image data of which luminance value is calculated by the calculation unit is a reference frame in frames constructing a moving picture.

7. The image display apparatus of claim 6, wherein the conversion unit keeps each pixel converted to have a lowest luminance value of the reference frame in the lowest luminance value until it reaches to a next reference frame.

8. The image display apparatus of claim 5, wherein the pixel having the lowest luminance value is a pixel that is not lighted.

9. A display method of an image display apparatus with a display unit which has a plurality of arranged pixels composed of self-emitting devices comprising:
converting a pixel having a second lowest luminance value next to a pixel having a lowest luminance value among pixels composing the image data, into a pixel having a lowest luminance value, until a total luminance value which is a sum of luminance values of pixels of image data to be displayed on the display unit becomes a predetermined luminance value; and
displaying image data including the converted pixel on the display unit.

10. A display method of an image display apparatus with a display unit which has a plurality of arranged pixels composed of self-emitting devices comprising:
converting a pixel excluding a pixel having a lowest luminance value among pixels composing the image data, into a pixel having a lowest luminance value with higher frequency as a luminance value of a pixel is lower, until a total luminance value which is a sum of luminance values of pixels of image data to be displayed on the display unit becomes a predetermined luminance value; and
displaying image data including the converted pixel on the display unit.
